(19) United States
(12) Patent Application Publication
(10) Pub. No.: US 2012/0006172 A1
(43) Pub. Date: Jan. 12, 2012

(54) DEVICE FOR SEPARATING PACKAGES FROM A CARRIER BELT HAVING SUCCESSIVELY ARRANGED BLISTER BUBBLES

(75) Inventors: Oliver Krüger, Kirchzarten (DE); Ralph Ludwig, Freiburg (DE); Stephan Knotz, Todtnau-Brandenberg (DE); Timo Rümmele, Utzenfeld (DE); Johannes Wunderle, Todtnau-Aftersteg (DE)

(73) Assignee: ZAHORANSKY AG, Todtnau (DE)

(21) Appl. No.: 13/170,309

(22) Filed: Jun. 28, 2011

(30) Foreign Application Priority Data
Jul. 10, 2010 (DE) 102010026801.1

(51) Int. Cl. B26D 1/20

(52) U.S. Cl. 83/592

(57) ABSTRACT

A device (1) for separating packages (2) from a carrier belt with successively arranged blister bubbles (5), which is connected to a cover layer (9). The device has a receiving element (3) with cavities (4) or recesses to accept the blister bubbles (5) of a carrier belt section (6) and supports (7) located lateral as well as between the cavities (4) or recesses for the flat side of the blister edges. An impinging roller (10) is arranged with a drive for rolling on the cover layer (9) of the carrier belt section (6) arranged in the receiving element (3). The impinging roller (10) has a number of cutting or pressing elements (12, 13) arranged behind each other with their number adjusted to the number of packages (2) to be separated from the respective carrier belt section (6) and/or the supports (7) of the receiving elements (3) each comprise cutting or pressing element (12, 13) for completely or partially cutting the individual packages (2) from the carrier belt section (6) or for creating material weaknesses between the individual packages (2).

### CROSS-REFERENCE TO RELATED APPLICATIONS

This application claims the benefit of German Patent Application No. 102010026801.1, filed Jul. 10, 2010, which is incorporated herein by reference as if fully set forth.

### BACKGROUND

Numerous objects, for example toothbrushes, are sold in blister packages. During packaging blister bubbles are formed in a carrier belt comprising a plastic film, into which objects are inserted. The carrier belt is then covered with a cover layer, for example made from cardboard, and the carrier belt and the cover layer are connected to each other. Subsequently the individual packages are cut or punched from the carrier belt comprising one blister bubble each. The cutting or punching occurs here in a clocked fashion for one or more packages each using a tool linearly controlled via toggle levers, as described for example in DE 10 2007 024 710 A1. Here, high cutting forces are required, for example 10-20 kN. Additionally, the structural expense is very high in order to allow precise cuts and the assembly of the cutting tools is rather cumbersome due to the narrow cutting gap between the plunger and the matrix of the toggle lever arrangement.

Another major disadvantage of the cutting device of prior art comprises that during cutting or punching a bar develops between neighboring blisters as cutting waste. Each of these bars has a width of usually 4-6 mm, so that in serial production large amounts of waste develop. This results on the one hand in high costs due to the additional material consumed and is also ecologically disadvantageous because the bars comprise film material and material of the cover layer connected thereto. Thus, a separating and recycling of this material in a pure form is not possible or only in a very labor-intensive manner and thus appropriately expensive.

### SUMMARY

Therefore the objective is to provide a device according to the type mentioned at the outset, which is of a simple design and shall be easily maintained. Additionally, a separation of the packages shall be possible with the use of reduced forces. Furthermore, waste material by bars remaining between the individual packages shall be avoided.

The objective is attained according to the invention such that a receiving element is provided with cavities or recesses to accept the blister bubbles of a carrier belt section and with supports, located laterally as well as between the cavities or recesses, for the edges of the blisters at the flat side, wherein an impinging roller is provided with a drive for rolling on the cover layer of the carrier belt section arranged in the receiving element, and that the impinging roller comprises a number of cutting or pressing elements arranged successively, adjusted to the number of packages to be separated from the respective carrier belt section, and/or the supports of the receiving element each comprise cutting or pressing elements for a complete or partial cutting of individual packages from the carrier belt section or for inserting material weakening between individual packages.

A carrier belt section with a number of blister bubbles is formed from a film in an upstream forming device and filled with the objects to be packaged at the assembly station, and after the carrier belt section was connected to a cover layer at a connection device, it is brought into the area of the receiving element. The blister bubbles are here arranged in the cavities or recesses of the receiving element and the carrier belt section is supported on the supports of the receiving element. In such a carrier belt section, placed in the receiving element and stationary, the impinging roller is moved over the carrier belt section and thus the individual packages are cut out or separated from each other by a material weakening. By the rolling motion of the impinging roller the respective contacting area is small, therefore requiring considerably lower cutting forces for the device and thus the wear is reduced and the life of the device is increased. By the successive arrangement of the cutting or pressing element in the longitudinal direction of the receiving element and/or in the rolling direction of the impinging roller no intermediate bars develop as waste during the separation, thus reducing the material required and allowing an economically as well as ecologically advantageous production.

In an optimally adjusted positioning of the receiving element and the impinging roller in reference to each other their distance in reference to each other during processing is sized such that the carrier belt section with the cover layer is cut or compressed by the cutting or pressing elements in just the desired manner, however the cutting or pressing elements are not contacting the opposite cutting or pressing elements or the counter surface, thus wear is reduced and the life of the device is increased.

It is possible for the impinging roller to carry the cutting or pressing elements and the receiving element comprising flat supports as counter elements thereto. However, it is also possible that the receiving element carries the cutting or pressing elements and the impinging roller has a flat counter surface. Finally it is possible that both the impinging roller as well as the receiving element carry cutting or pressing elements so that a corresponding impinging of the carrier belt section with the cover layer occurs from both sides.

Cutting elements may be provided in order to cut individual packages completely from the carrier belt section. However, pressing elements are also possible that allow a folding of two still connected packages. A combination of cutting and pressing elements is also possible, for example an alternative arrangement of cutting and pressing elements so that the packages are each cut out in pairs from the carrier belt and each two connected packages exhibit a material weakening at their connecting area at which the packages can be folded.

After the complete rolling of the impinging roller on the receiving element the cut-out packages are resting on the receiving element and can be removed or ejected, which can occur automatically or manually. Here, the displacement path of the impinging roller preferably exceeds the receiving element so that all receptacles are freely accessible and allow a problem-free removal or ejection of the packages.

It is beneficial for the impinging roller to comprise a carrier roller and several cutting or pressing elements mounted thereon in a detachable fashion, arranged successively in the circumferential direction of the carrier roller, and adjusted to the packages to be separated. The cutting or pressing elements can then easily be exchanged in order to use the device for different packages or to exchange damaged or worn cutting or pressing elements. Cutting or pressing elements can be provided for one package each or larger cutting or pressing elements sized for several packages, so that overall fewer individual parts are provided and the assembly of the carrier roller can be accomplished more easily and quickly.

In order to allow inserting a carrier belt section into the device and to move the impinging roller back into its normal position after processing without once more impinging the already separated packages it is advantageous for the receiving element and/or the impinging roller to be positioned perpendicularly in reference to the carrier belt level. In particular, the receiving element can be lowered, the carrier belt section can be fed, and the receiving element can then be lifted off again, allowing the individual blister bubbles to enter into the cavities or recesses and the carrier belt section resting on the support of the receiving element.

The drive for the impinging roller may comprise a linear drive for the linear displacement of the impinging roller along the carrier belt section as well as a rotary drive for a rotational motion of the impinging roller during the linear displacement.

Alternatively, the drive for the impinging roller may comprise a rotary drive for a rotational motion of the impinging roller and the rotary axis of the impinging roller may here be connected to a sprocket in a torque-proof fashion, which here engages a gear rack extending along the receiving element for the carrier belt section to be processed. The rotary motion of the impinging roller is converted this way via the sprocket/gear rack mechanics into an additional linear motion and only a single motor is required, allowing a realization of the drive in a simple, space-saving, and cost-effective manner.

It is also possible for the drive to comprise a linear drive for the impinging roller for a linear displacement of the impinging roller along the carrier belt section, and that the rotary axis of the impinging roller is connected to a sprocket in a torque-proof fashion, which in turn engages a gear rack extending along the receiving element for the carrier belt section to be processed. Therefore, no rotary drive is required. The rotary motion is achieved by the rolling of the sprocket over the gear rack. The linear drive can here be a hydraulic drive, for example.

A preferred embodiment provides for the impinging roller to comprise lateral support rings, which rest on support areas extending along the receiving element for the carrier belt section to be processed. This allows a precise positioning of the impinging roller and the receiving element in reference to each other with regards to distance and thus the adjustment of the gap between the cutting or pressing elements and the counter surfaces so that preferably the cutting or pressing elements in the respective processing position extend to the counter surfaces, which as described above may also be formed as cutting or pressing elements or as flat counter surfaces, without actually impinging them with any effective force. In this manner wear is avoided and the life of the device is increased.

Here, the receiving element may preferably comprise the rolling surfaces, which facilitates the construction.

Additionally it is beneficial for the support rings to be embodied conical in the axial direction and to be supported at the impinging roller in an axially adjustable fashion, and for the support surfaces to exhibit a conical surface adjusted to the conical surface of the support rings. By a respective axial positioning of the support rings the distance between the impinging roller and the receiving element can be adjusted this way, for example to compensate wear of the cutting or pressing elements and to ensure a consistent gap between the impinging roller and the receiving element.

The cutting elements can have one or more recesses along their cutting edges. This allows the production of partially punched-out packages, which are initially still connected, and perhaps also remain in a frame of the carrier belt section, and this way reach the retailer where the customer can separate an individual package from this aggregation. In case of a multitude of recesses a perforation may be created, too, which on the one hand ensures a secure connection of the packages and on the other hand allows a simple separation of individual packages from the aggregation.

The linear drive direction of the impinging roller can be offset in reference to the direction of the longitudinal extension of the receiving element and the carrier belt section supported therein by an angle α and the cutting or pressing elements can each be arranged at a respective angle diagonal in reference to the impinging roller.

The impinging roller can therefore roll diagonally over the carrier belt section. This is advantageous in that the respective contact surface is reduced at any point of time during the rolling of the impinging roller on the carrier belt section located in the receiving element, perhaps showing only two or three points, by which the compression force between the impinging roller and the receiving element can be further reduced.

In order to prevent the wear and tear and thus to increase the life of the device it is beneficial for the cutting or pressing elements of the impinging roller and/or the cutting or pressing elements or the supports of the receiving element to comprise a hardened material.

It may be beneficial for the impinging roller to comprise an impinging section equipped in the circumferential direction with cutting or pressing elements as well as a free gap section. In such an embodiment of the impinging roller any lifting or positioning lateral in reference to the level of extension of the carrier belt section can be avoided when the impinging roller returns after processing, because the impinging roller can return without contacting the carrier belt section when the gap section faces the carrier belt section. The impinging roller must here show a respective diameter and circumference in order to show an impinging section with an appropriate number of cutting or pressing elements to separate the desired number of packages in spite of the gap section. Additionally, the displacement path of the impinging roller along the receiving element and beyond is respectively longer.

The cutting or pressing elements can be provided with additional impinging areas within their exterior contour. They may perhaps be provided for inserting a perforation within the separated packaging, for example for an initially closed suspension hole.

The invention also relates to a packaging with a blister bubble and a cover layer closing a blister bubble that can be produced with the device according to the invention. The packaging according to the invention is characterized in the exterior edges of the cover layer and/or the blister edges supporting the cover layer being free from burrs and/or being rounded. This way, no sharp cutting edges are present and the risk of injuries when handling the packaging, particularly when opening it, is avoided or at least strongly reduced.

### BRIEF DESCRIPTION OF THE DRAWINGS

In the following, exemplary embodiments of the device according to the invention are explained in greater detail using the drawings.

Shown in a partially schematic illustration are:

FIG. 1 is a perspective view of a device prior to separating the packages;

FIG. 2 is a view of the device of FIG. 1 after the separation of the packages;

FIG. 3 is a view of an individual cutting element;

FIG. 4 is a view of a carrier belt section after the separation of the packages;

FIG. 5 is a perspective view of another embodiment of a device prior to separating the packages;

FIG. 6 is a view of the device of FIG. 5 after the separation of the packages;

FIG. 7 is a front elevational view of the arrangement of FIG. 6;

FIG. 8 is a view of an individual cutting element like the one used on the impinging roller according to FIGS. 5 through 7;

FIG. 9 is a view of a carrier belt section after the separation of the packages with a cutting element according to FIG. 8;

FIG. 10 is a perspective view of another exemplary embodiment of a device with a diagonally rolling impinging roller prior to the separation of the packages;

FIG. 11 is a top view of the arrangement of FIG. 10;

FIG. 12 is a perspective view of a device of FIG. 10 after the separation of the packages;

FIG. 13 is a top view of the arrangement of FIG. 12;

FIG. 14 is a view of an individual cutting element as used on the impinging roller according to FIGS. 10 through 13;

FIG. 15 and FIG. 16 are each front elevational views of a device with conically extending support rings;

FIG. 17 to FIG. 22 are cross-sectional views through a support of the receiving element and the impinging roller when separating a package with differently embodied cutting or pressing elements, and

FIG. 23 and FIG. 24 are each a cross-sectional views through a cut-out package.

### DETAILED DESCRIPTION OF THE PREFERRED EMBODIMENTS

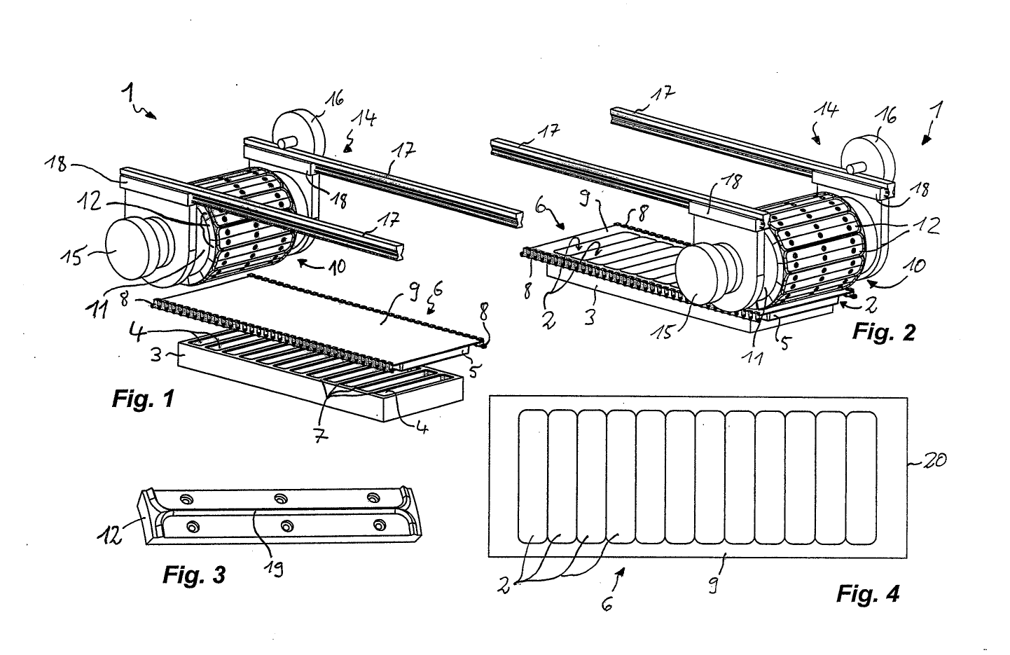

According to FIG. 1, a device marked 1 in its entirety for separating packages 2 form a carrier belt comprises a receiving element 3 with cavities 4 to accept the blister bubbles 5 of a carrier belt section 6 and with supports 7, located laterally as well as between the cavities 4, for the blister edges at the flat side.

A forming device, not shown, is provided upstream in reference to the device 1 for forming blister bubbles with a subsequent assembly device to insert the objects to be packaged in the blister bubbles and a device for connecting the blisters with a cover layer 9. This cover layer 9 may for example comprise film or cardboard, which in turn is rolled off a coil or is provided in the form of sheets, and which are glued or welded to the blister film belt.

The carrier belt section 6 is transported via two lateral guide chains 8. In the exemplary embodiment one carrier belt section 6 with 12 blister bubbles 5 each is processed. After the carrier belt section 6 has been transported into the range of the receiving element 3 as shown in FIG. 1, the receiving element 3 is raised until the individual blister bubbles 5 are located in the cavities 4 of the receiving element 3 and the blister bubbles rest on the supports 7 of the receiving elements 3.

Subsequently an impinging roller 10 is lowered onto the carrier belt section 6. The impinging roller 10 comprises a carrier roller 11 and several cutting elements 12 mounted thereon in a detachable fashion. These cutting elements 12 impinge the carrier belt section 6 when the processing roller 10 (FIG. 2) is in the lowered position. In the lowered position in reference to an initial position (FIG. 1) the impinging roller 10 is moved by a linear drive 14 into an end position (FIG. 2), with the impinging roller 10 during said linear displacement rolling over the carrier belt section 6. For this purpose, a rotary drive 15 is provided. The linear drive 14 comprises a drive motor 16, two lateral guide rails 17, as well as suspension elements 18 guided therein for the processing roller 10.

The cutting elements 12 each impinge the carrier belt section 6 and in this way cut the individual packages 2. Due to the fact that only a very small contact area is formed between a cutting element 12 and a carrier belt section 6 it is possible to work with a relatively low compression. The lateral bar 19 of a cutting edge of the cutting element 12 (FIG. 3) forms the cutting line between two neighboring packages 2. This way, when separating the packages 2 no waste develops between the individual packages 2. This is easily discernible in the top view of a processed carrier belt section 6 according to FIG. 4. In addition to the individual packages 2, which can be removed or ejected from the cavities 4 of the receiving element 3, only an outer frame 20 remains as waste.

The individual cutting elements 12 are arranged on the carrier roller 11 such that its cutting edges follow each other continuously so that a complete cutting is achieved.

With an appropriate compression the rotary drive 15 can also be turned off during the lateral displacement of the impinging roller 10 because due to the mechanic compression of the impinging roller 10 to the carrier belt section 6 this rotary motion occurs automatically and the impinging roller 10 rolls over the carrier belt section 6. The rotary drive 15 can then be used, after the linear return of the impinging roller 10 into its initial position, for an exact positioning of the impinging roller 10.

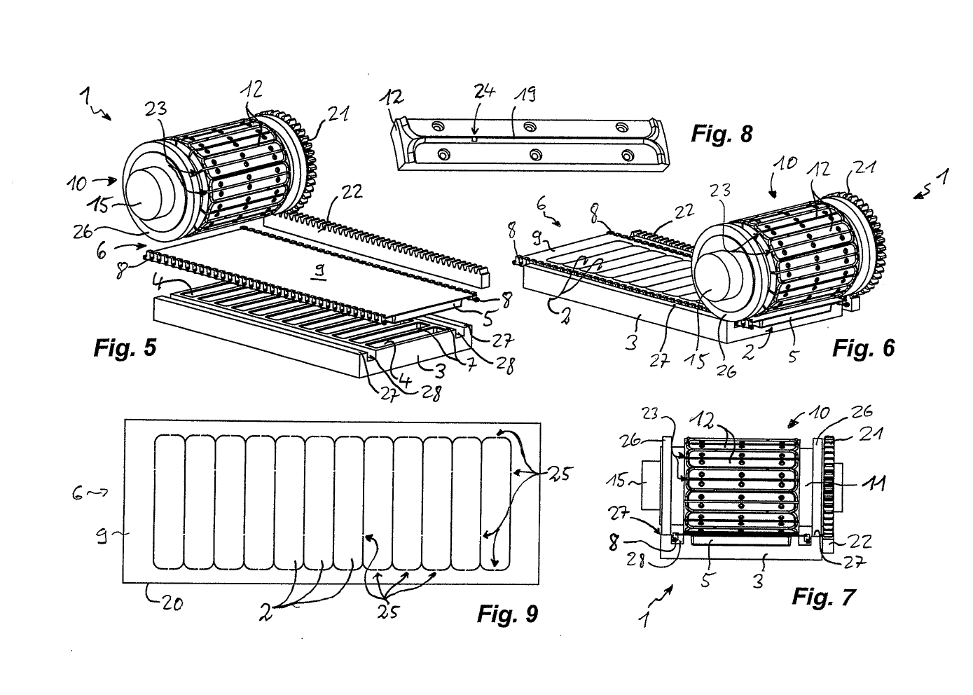

In the device 1 according to FIGS. 5 through 7, the rotary axis of the rotary drive 15 is connected to a sprocket 21 in a torque-proof fashion, which engages a gear rack 22 extending along the receiving element 3. This way, the rotary motion of the impinging roller 10 is superimposed by an additional linear motion and the need for a separate linear drive can be waived.

In the device according to the FIGS. 5 through 7, the individual cutting elements 12 are embodied shorter with regards to the circumferential direction of the impinging roller 10 than in the embodiments according to FIGS. 1 and 2, thus forming a gap 23 each between the individual cutting elements 12 arranged on the carrier roller 11, interrupting the cutting line. Additionally the lateral bar 19 of the cutting edge provides one recess 24 each (FIG. 8). This way, the packages 2 are not completely separated from the carrier belt section 6 but remain connected to each other and to the frame 20 of the carrier belt section 6 via narrow bars 25 (FIG. 9). This way, the entire carrier belt section 6 with the frame 20 can be placed into a sales display and a customer him/herself can separate a package from the compound.

When several recesses 24 are provided at the lateral bar 19, a perforation may be performed as well.

As particularly discernible in FIG. 7, the impinging roller 10 comprises lateral support rings 26, which rest on support surfaces 27 extending along the receiving element 3. Here, the support surfaces 27 and the receiving element 3 form a unit, with grooves 28 being provided between the support surfaces 27 and the supports 7 for accepting the guiding chains 8 for the support belt section 6.

The outer diameter of the support rings 26 is here selected such that the cutting elements 12 precisely meet the supports 7 of the receiving elements 3 without here enacting any strong force upon the support 7. This way, on the one hand a reliable separation of the packages 2 is ensured from the support belt section 6, on the other hand the supports 7 are not damaged by the cutting elements 12 and also the cutting elements 12 are not worn or damaged by impinging the supports 7 of the receiving elements 3 commonly produced from hardened steel. This allows a long life of the device 1.

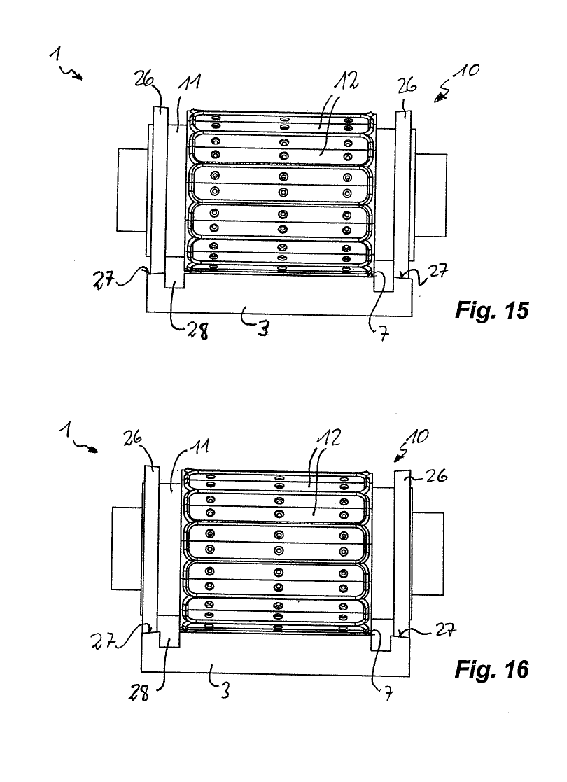

FIGS. 15 and 16 show a further development, in which the support rings 26 are embodied conically in the axial direction. The support surfaces 27 have a tapered surface adjusted to this contour. The support rings 26 are additionally supported in an axially adjustable fashion. By an axial adjustment of the support rings 26 the distance can be adjusted between the supports 7 of the receiving element 3 and the cutting element 12 of the impinging roller 10. This may be particularly beneficial in order to compensate the increasing distance when the cutting element 12 is worn and this way it ensures a constant cutting quality. FIG. 15 shows the device 1 with support rings 26 axially positioned closer together. FIG. 16 shows the support rings 26 axially displaced outwardly so that the impinging roller 10 is positioned closer to the receiving elements 3.

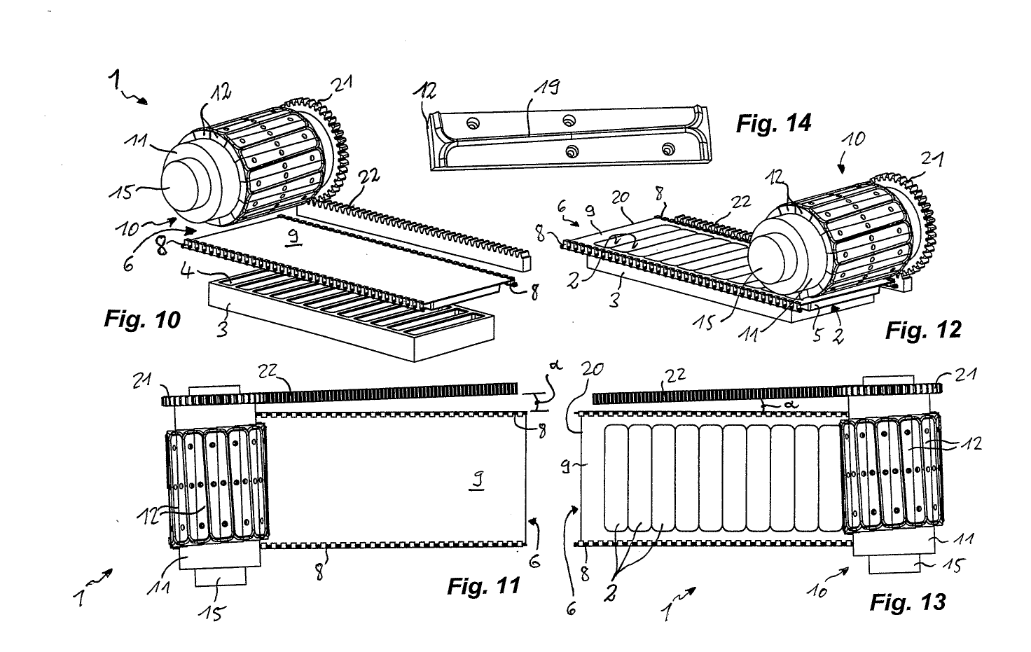

In the device 1 according to FIGS. 10 through 13 the linear direction of progression of the impinging roller 10 is off-set by an angle α (FIG. 11) in reference to the direction of the longitudinal extension of the receiving element 3 and the support belt section 6 supported therein. The individual cutting elements 12 (FIG. 14) are each respectively embodied diagonally and arranged on the carrier roller 11 in order to still obtain straight cuts for the packages 2, corresponding to the blister bubbles 5, (FIGS. 12, 13) when rolling the impinging roller 10 on the carrier belt section 6.

This way, the respective contact surface between the impinging roller 10 and the carrier belt section 6 is reduced during the rolling of the impinging roller 10, thus it is possible to work with lower pressures between the impinging roller 10 and the receiving element 3. Ideally the contact surface only comprises two or three points at any point of time during the rolling motion.

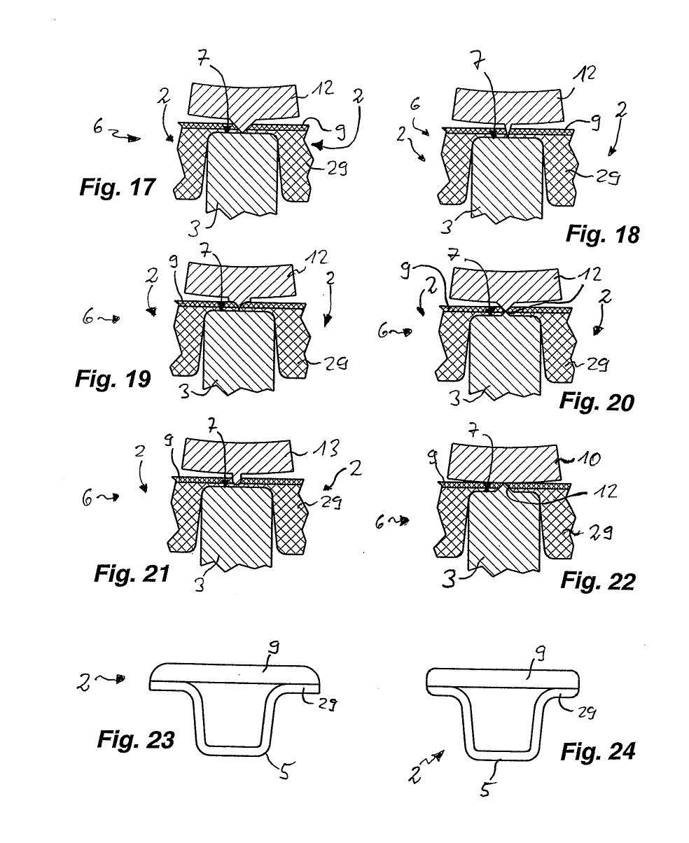

FIGS. 17 through 22 are different combinations of cutting and pressing elements 12, 13 impinging the carrier belt section 6 made from blister material 29 and a cover layer 9, each shown in a cross-section.

Here, in FIGS. 17 through 19 the impinging roller, not shown, respectively comprises cutting elements 12 and the support 7 of the receiving element 3 is a planar area.

In FIG. 17 the cutting element comprises a cutting edge for separating two packages 2, with their cutting edges forming an angle of approximately 90°. A package separated by such cutting elements 12 is shown in FIG. 23, with the object to be packaged in the blister bubble 5 itself not being shown. By impressing the cover layer 9 from the top, the cutting edges of the cutting element 12 press the cover layer material inwardly, leading to a lasting deformation. This way the cover layer 9, commonly made from cardboard, exhibits no sharp corners and edges. The edges are free from burrs and rounded. This way any risk of injury of the finished packaging 2 is avoided.

The embodiments according to FIGS. 18 and 19 are similar to the ones of FIG. 17, with in FIG. 18 a more acute cutting angle and in FIG. 19 a profiled edge being provided.

In FIG. 20 a cutting element 12 is also provided at the support 7 of the receiving element 3. This way the carrier belt section is simultaneously impinged by both cutting elements from the top and the bottom and a packaging 2 results as shown in FIG. 24, in which both the edges of the cover layer 9 as well as the blister material 29 located therebeneath being rounded and free from burrs and any sharp edges of the packaging are even better removed.

In the device according to FIG. 21, instead of a cutting element, a dull pressing element 13 without any cutting edges is provided, by which the adjacent packages 2 are not separated from each other, but only a material weakening is formed by way of an impression. This allows for example a folding of adjacent packages 2 at these separation lines.

Along an impinging roller 10, for example cutting element 12 and pressing element 13 may be arranged alternating behind each other in order to form packaging pairs, which can be sold as double packs.

The distance between the impinging roller 10 and the support 7 of the receiving element 3 is here sized such that a gap remains and the press element 13, as shown in FIG. 21, presses through the cover layer 9 but not through the blister material 29.

In FIG. 22 the impinging roller 10 itself comprises neither a cutting nor a pressing element, but only serves as the counter support for the cutting element 12 arranged on the support 7 of the receiving element 3. The cut for separating the packages 2 occurs here exclusively from the bottom.

1. A device (1) for separating packages (2) from a carrier belt with successively arranged blister bubbles (5), connected to a cover layer (9), the device comprising a receiving element (3) including cavities (4) or recesses for accepting the blister bubbles (5) of a carrier belt section (6) and with supports (7), located both lateral as well as between the cavities (4) or recesses, for supporting the blister edges at a flat side, an impinging roller (10) having a drive for rolling the impinging roller on the cover layer (9) of the carrier belt section (6) arranged in the receiving element (3), and at least one of the impinging roller (10) comprises a number of cutting or pressing elements (12, 13) arranged successively and with a number thereof being adjusted to the packages (2) to be separated from the respective carrier belt section (6) or the supports (7) of the receiving element (3) each comprise cutting or pressing elements (12, 13) for completely or partially cutting out the individual packages (2) from the carrier belt section (6) or to create material weak spots between the individual packages (2).

2. The device according to claim 1, wherein the impinging roller (10) comprises a carrier roller (11) and several cutting or pressing elements (12, 13) that are detachably fastened thereon, arranged behind each other in a circumferential direction of the carrier roller (11) and adjusted to the packages (2) to be separated.

3. The device according to claim 1, wherein at least one of the receiving element (3) or the impinging roller (10) can be positioned perpendicularly in reference to a plane of the carrier belt.

4. The device according to claim 1, wherein the drive for the impinging roller (10) comprises a linear drive (14) for a linear displacement of the impinging roller (10) along the carrier belt section (6) and a rotary drive (15) for a rotary motion of the impinging roller (10) during the linear displacement.

5. The device according to claim 1, wherein the drive for the impinging roller (10) comprises a rotary drive (15) for a rotary motion of the impinging roller (10), and the rotary axis of the impinging roller (10) is connected to a sprocket (21) in a torque-proof fashion, that engages a gear rack (22) which extends along the receiving element (3) for the carrier belt section (6) to be processed.

6. The device according to claim 1, wherein the drive for the impinging roller (10) comprises a linear drive (14) for a linear displacement of the impinging roller (10) along the carrier belt section (6), and a rotary axis of the impinging roller (10) is connected in a torque-proof fashion to a sprocket (21), which engages a gear rack (22) extending along the receiving element (3) for the carrier belt section (6) to be processed.

7. The device according to claim 1, wherein the impinging roller (10) comprises lateral support rings (26) that rest on support surfaces (27) extending along the receiving element (3) for the carrier belt section (6) to be processed.

8. The device according to claim 7, wherein the receiving element (3) includes the support surfaces (27).

9. The device according to claim 7, wherein the support rings (26) are embodied conically in an axial direction thereof and are axially adjustable on the impinging roller (10) and the support surfaces (27) have a tapered surface complementary to the conical surface of the support rings (26).

10. The device according to claim 1, wherein the cutting elements (12) include one or more recesses (24) along cutting edges thereof.

11. The device according to claim 1, wherein a linear direction of progression of the impinging roller (10) in reference to a longitudinal direction of extension of the receiving element (3) and the carrier belt section (6) supported therein is off-set by an angle α, and the cutting or pressing elements (12, 13) each are arranged at a respective angle diagonal on the impinging roller (10).

12. The device according to claim 1, wherein at least one of the cutting or pressing elements (12, 13) of the impinging roller (10) or the cutting or pressing elements (12, 13) or the supports (7) of the receiving element (3) are made from a hardened material.

13. The device according to claim 1, wherein different cutting or pressing elements (12, 13) are provided on the impinging roller (10).

14. The device according to claim 1, wherein the impinging roller (10) comprises in a circumferential direction an impinging section equipped with the cutting or pressing elements (12, 13) as well as a free gap section.

15. A package (2) comprising a blister bubble (5) and a cover layer (9) sealing the blister bubble (5), the exterior edges of at least one of the cover layer (9) or the blister edges carrying the cover layer are free from burrs and/or are rounded.
